(19) United States
(12) Patent Application Publication
(10) Pub. No.: US 2025/0344894 A1
(43) Pub. Date: Nov. 13, 2025

(54) Portable capsule coffee machine

(71) Applicants: Jun LI, Shanghai (CN); Yuhan TENG, Shanghai (CN)

(72) Inventors: Jun LI, Shanghai (CN); Yuhan TENG, Shanghai (CN)

(73) Assignee: Shanghai Xiangpinka Technology Co., LTD, Shanghai (CN)

(21) Appl. No.: 18/761,534

(22) Filed: Jul. 2, 2024

(30) Foreign Application Priority Data
May 8, 2024 (CN) 202420981543.5

(51) Int. Cl. A47J 31/00; A47J 31/02; A47J 31/52

(52) U.S. Cl. CPC A47J 31/005; A47J 31/02; A47J 31/521

(57) ABSTRACT

The present disclosure provides a portable capsule coffee machine. The portable capsule coffee machine includes a spraying system, a liquid pumping system and a control unit. The spraying system includes an accommodating component and a liquid collecting tank sealed and mounted at a bottom of the accommodating component. A liquid inlet tube of the liquid pumping system may extend into the internal liquid of a cup body. The liquid pumping system the liquid in the cup body may be used to spray a coffee capsule. The control unit includes a control panel, a circuit board and a power supply, and the circuit board is electrically connected to the power supply and the liquid pumping system respectively.

### CROSS REFERENCE TO RELATED APPLICATIONS

This application claims priority benefits to Chinese Patent Application No. 2024209815435, filed on May 8, 2024, the contents of which are incorporated herein by reference.

### TECHNICAL FIELD

The present disclosure relates to the technical field of coffee machines, and in particular, to a portable capsule coffee machine.

### BACKGROUND

Most capsule coffee machines currently on the market are used in home and office scenarios and rely on traditional power sockets for power supply. In contrast, portable capsule coffee machines tend to adopt manual pressurization approach. Although there are a few electric machines on the market that try to meet immediate needs, these machines are often difficult to operate due to their complex structure, cumbersome operation, and high cost. A user must prepare hot water on site, which is inconvenient due to the tiny water storage space. The process is not only cumbersome, but also has potential safety hazards. For example, hot water splashing may cause accidental burns. The limitation of this approach is that hot water cannot be pre-stored. This is particularly inconvenient in outdoor scenarios because an additional heat source needs to be found to boil water. If more coffee is needed, the trouble of repeatedly adding water is caused. The whole process involves multiple steps, such as adding water, sealing the capsule coffee, starting the machine, with each step requiring precise operation. If not careful, such as not tightening some components, it will directly affect normal preparation of coffee, further reducing the fluency and experience of use.

### SUMMARY

The embodiments of the present disclosure provide a portable capsule coffee machine. The portable capsule coffee machine includes a spraying system, a pumping system and a control unit. The spraying system includes an accommodating component and a liquid collecting tank mounted on a bottom of the accommodating component. A spraying space is formed between the accommodating component and the liquid collecting tank, and the spraying space is configured to accommodate a coffee capsule. A liquid inlet tube of the pumping system is configured to extend into internal liquid in a cup body, a liquid outlet tube of the pumping system is connected to the spraying system, and the pumping system is configured to extract liquid from the cup body and transfer the liquid to the liquid outlet tube to allow the liquid to enter an interior of the accommodating component to realize the spraying of the coffee capsule. The control unit includes a control panel for operating an instruction, a circuit board for executing a control instruction, and a power supply unit for providing required electrical energy. The circuit board is electrically connected to the power supply unit and the pumping system respectively.

### BRIEF DESCRIPTION OF DRAWINGS

The description and drawings that constitute part of the present disclosure are provided for a further understanding of the present disclosure. The illustrative embodiments and their descriptions are provided for explanation but do not constitute improper limitations of the present disclosure.

FIG. 1 is an overall exploded schematic structural view of a portable capsule coffee machine.

FIG. 2 is an internal schematic structural view of a cover of a portable capsule coffee machine.

FIG. 3 is a schematic structural view of a filter of a portable capsule coffee machine.

FIG. 4 is an internal schematic structural view of an accommodating component and a cover of a portable capsule coffee machine.

FIG. 5 is a schematic view of the connection relationship between a cover and a covering plate of a portable capsule coffee machine.

FIG. 6 is an overall schematic structural view of a portable capsule coffee machine.

### DETAILED WAY

The present disclosure will be described in detail below with reference to the accompanying drawings and in conjunction with various embodiments. Each example is provided to explain but not limit the present disclosure. In fact, it will be clear to those of ordinary skill that modifications and variations may be made without departing from the scope or spirit of the present disclosure. For example, a feature shown or described as part of one embodiment may be used according to another embodiment to produce yet another embodiment. Therefore, it is desired that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientation or position relationship based on the orientation or position relationship shown in the drawings, which is only for the convenience of describing and does not require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may be a wired electrical connection, a radio connection, or a wireless communication signal connection. For those of ordinary skill in the art, the specific meanings of the above terms may be understood according to the specific circumstances.

One or more examples of the present disclosure are shown in the attached drawings. Numbers and letter signs are used in the detailed description to refer to features in the drawings. Similar marks in the drawings and descriptions have been configured to refer to similar parts of the present disclosure. As used herein, the terms “first”, “second” and “third” are used interchangeably to distinguish one component from another, and are not intended to indicate the position or importance of individual components.

### Embodiment 1

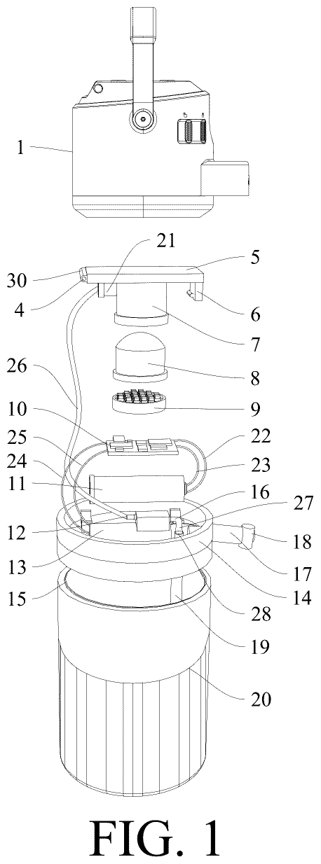

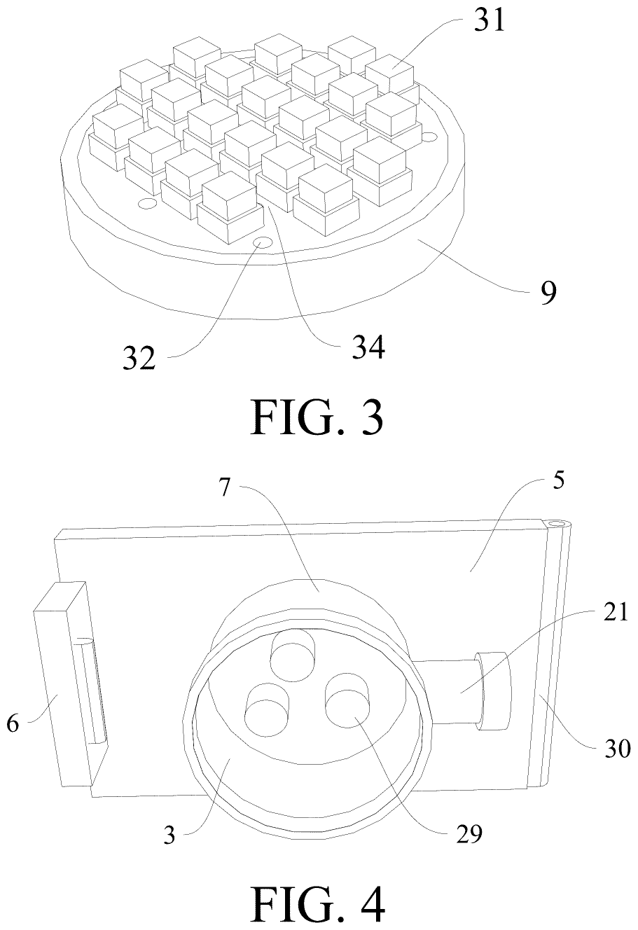

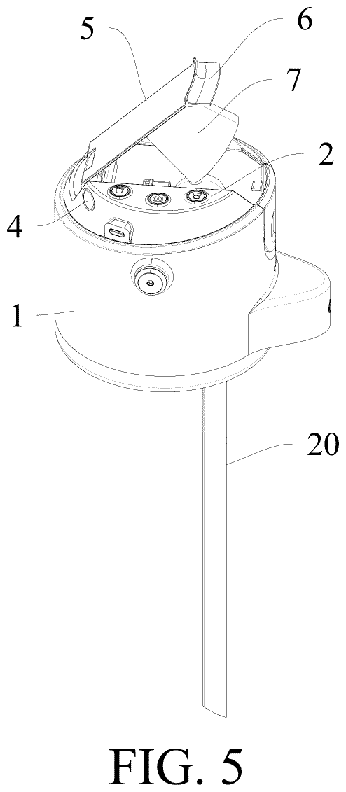

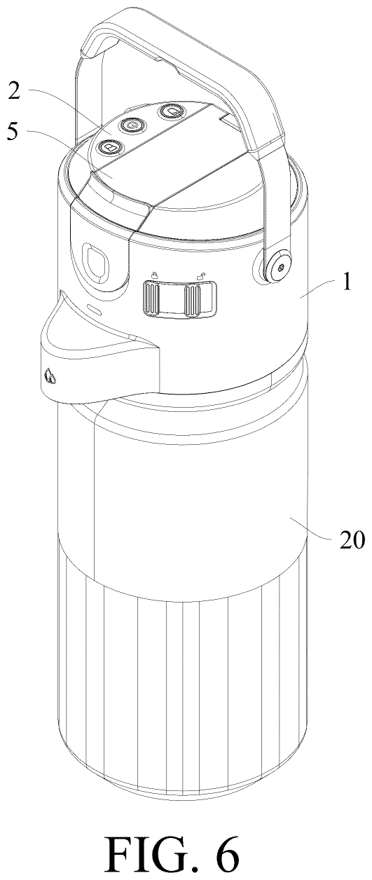

As illustrated in FIG. 1 to FIG. 6, a portable capsule coffee machine includes a cup body 20 and a spraying system. The cup body 20 may be a cup body with a heating function, a cup body with a heating pack provided outside for heating, or a vacuum insulation cup body. The spraying system includes an accommodating component 7 and a liquid collecting tank 33. The liquid collecting tank 33 may be sealed and mounted on a bottom of the accommodating component 7. A spraying space 3 which may accommodate a coffee capsule 8 is defined between the accommodating component 7 and the liquid collecting tank 33. A liquid pumping system includes a pumping motor 13. A pipeline is connected to a liquid inlet tube 19 and a liquid outlet tube 26 of the pumping motor 13. The liquid inlet tube 19 of the liquid pumping system may extend into an interior of the cup body 20 and contacts the internal liquid in the cup body 20. The liquid outlet tube 26 of the liquid pumping system is connected to the spraying system, and the liquid pumping system may extract the liquid in the cup body 20 and transfer it to the liquid outlet tube 26. Then, the liquid may enter the interior of the accommodating component 7, thereby achieving the spraying of the coffee capsule 8. A control unit includes a control panel 2 for operating an instruction, a circuit board 10 for executing a control instruction and a power supply 11 for providing required electrical energy. The circuit board 10 is electrically connected to the power supply 11 and the liquid pumping system respectively. A lower cover 14 is arranged at an upper end of the cup body 20. A pumping motor 13 is fixedly mounted inside the lower cover 14. The pumping motor 13 is arranged with a first liquid outlet 12 and a first liquid inlet 16. A liquid inlet tube 19 is arranged inside the cup body 20. The first liquid inlet 16 is connected to an interface 28 of a top of the liquid inlet tube 19 through the liquid inlet tube 27. A covering plate 5 is arranged above the lower cover 14. A second liquid inlet 21 is arranged on a lower end of the covering plate 5. The first liquid outlet 12 is connected to the second liquid inlet 21 through the liquid outlet tube 26. The accommodating component 7 is fixedly mounted on a lower end of the covering plate 5. The accommodating component 7 and the covering plate 5 are integrally arranged or separately arranged. When the accommodating component 7 and the covering plate 5 are separately arranged, the accommodating component 7 and the covering plate 5 may be detachably connected or fixedly connected.

The accommodating component 7 is provided with a coffee capsule 8. A lower end of the liquid inlet tube 19 is disposed on a bottom of the cup body 20 for extracting water conveniently. A circuit starting device is provided to enable the water pumping motor 13 to work, and then the liquid inlet tube 19 may extract the water previously loaded in the cup body 20 by the user. The first liquid inlet 16 is connected to the interface 28 of a top of the liquid inlet tube 19 through the liquid inlet tube 27, and the liquid inlet tube 27 is tightly fitted with the interface 28. Therefore, the water in the liquid inlet tube 19 enters the first liquid inlet 16 through the liquid inlet tube 27. A first liquid outlet 12 and the first liquid inlet 16 are arranged on the water pumping motor 13, and the water in the first liquid inlet 16 enters the first liquid outlet 12. The first liquid outlet 12 is connected to the second liquid inlet 21 through the liquid outlet tube 26, and the liquid outlet tube 26 is closely connected to the second liquid inlet 21, such that water flows into the second liquid inlet 21 through the liquid outlet tube 26. When a puncturing device arranged in the accommodating component 7 works, the coffee capsule 8 placed under the accommodating component 7 is punctured. The liquid extracted by the pumping motor 13 is injected into the coffee capsule 8 through the second liquid inlet 21, the coffee is extracted. The extracted coffee flows into a container through a diversion device, such that the user may enjoy more coffee outdoors. When the cup body 20 is filled with hot water, the user may enjoy hot coffee. When the cup body 20 is filled with ice water, the user may enjoy ice coffee. The purpose of using in different scenarios and meeting the needs of different users is realized.

As shown in FIG. 1 to FIG. 4, the accommodating component 7 is fixedly mounted with a plurality of puncturing components 29. The puncturing component 29 may be a needle. The puncturing components 29 are configured to puncture the coffee capsule 8. A lower end of the coffee capsule 8 is arranged with a filter 9, and a plurality of top column 31 is arranged inside the filter 9. The filter 9 is defined with a plurality of filter hole 32, and a lower end of the filter 9 is arranged with a liquid collecting tank 33. One end of the liquid collecting tank 33 is arranged with a flow guide tube, and the flow guide tube 17 extends into an interior of the liquid collecting tank 33. A flow guide head 18 is fixedly mounted on one end of the flow guide tube 17 away from the liquid collecting tank 33. The puncturing components 29 are provided to smoothly puncture the coffee capsule 8. The coffee capsule 8 is placed just above the liquid collecting tank 33. After the accommodating component 7 covers the coffee capsule 8, the coffee capsule 8 is pressed on the filter 9, so the coffee capsule 8 tightly contacts the filter 9. A silicone sealing ring is provided on an edge of the filter 9, which will be tightly pressed against the liquid collecting tank 33. The liquid in the cup is pumped out through the pumping motor 13, and the liquid is injected into the coffee capsule 8 through the second liquid inlet 21. As a result of backlog effect, the water pressure pushes a cover of the coffee capsule 8 onto the filter 9. The top columns 31 on the filter 9 will break the cover of the coffee capsule 8. A liquid flow channel 34 is formed between adjacent top columns 31 to allow the coffee liquid to flow out and squeeze the coffee liquid into the liquid collecting tank 33 below through the filter holes 32. The liquid collecting tank 33 is closely connected with the guide tube 17. The guide tube 17 is inclined downward to facilitate the coffee liquid to flow out from the guide tube 17 through the guide head 18. A container may be placed below the guide head 18 to catch the outflowing coffee liquid. The guide head 18 in the present embodiment may be an outflow switch valve or a guide valve.

### Embodiment 2

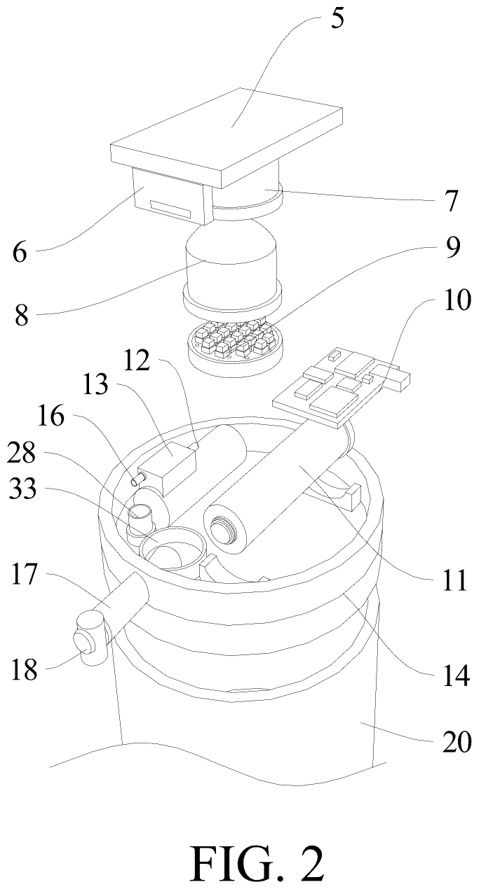

As shown in FIG. 1 and FIG. 2, a portable capsule coffee machine is provided. An inner wall of a cup body 20 is provided with a thread 15. The cup body 20 is screwed and connected with a lower cover 14 through the thread 15. A power supply 11 is fixedly mounted inside the lower cover 14, and a circuit board 10 is arranged above the power supply 11. The circuit board 10 is fixedly connected with the lower cover 14. The power supply 11 is connected with the circuit board 10 through a first line 22 and a second line 23. The circuit board 10 is connected with the pumping motor 13 through a third line 24 and a fourth line 25. The cup body 20 is arranged as a double-layer cup body, a vacuum state is formed between an inner wall and an outer wall, such that heat preservation may be better achieved. The cup body 20 is connected with the lower cover 14 through the thread 15, and the lower cover 14 may be closely connected with the cup body through the thread 15. The circuit board 10 is provided with a charging port, which is convenient for charging the battery or directly supplying power. A button and an indicator light are arranged on the circuit board 10, and the button is respectively connected to the control panel 2 on the cover body 1. The button control circuit 10 sends a signal to control the pumping motor 13. A power supply 11 or other power supply battery is used in the machine, or a USB direct power supply is adopted to provide power to the pumping motor 13. The power supply 11 is connected to the circuit board 10 through the first line 22 and the second line 23. Therefore, the power supply 11 provides power to drive the circuit board 10, such that the circuit board 10 may be used. The circuit board 10 is connected to the pumping motor 13 through the third line 24 and the fourth line 25, such that it may control the operation of the pumping motor 13. The machine has an indicator light and multiple buttons, which may control the operation of the motor through the circuit board 10 to control the squeezing pressure and volume of the coffee.

As shown in FIG. 1, a cover body 1 is arranged above the covering plate 5, and a buckle 6 is arranged on one side of the covering plate 5. The buckle 6 is buckled to the cover body 1. A connecting block 30 is arranged on one end of the covering plate 5 away from the buckle 6. A rotating shaft 4 is fixedly mounted inside the connecting block 30, and the rotating shaft 4 is rotatably connected to the cover body 1. A control panel 2 is arranged on one end of the cover body 1, and the covering plate 5 that may be opened upward is connected to the covering plate 5 through the rotating shaft 4. Therefore, the coffee capsule 8 may be placed conveniently when it is opened upward. A buckle 6 is arranged on the covering plate 5, such that the cover 5 is buckled and stuck on the covering plate 5 and will not be loosened. The buckle 6 of the covering plate 5 may be implemented in different ways, including but not limited to snap-in connection, plug-in connection, etc., which should be included in the protection scope of the present disclosure. A lower cover 14, the covering plate 5 capable of being opened upward, an accommodating component 7, a filter 9, and a liquid collecting tank 33 are arranged in the machine, and they are sealed to achieve high-pressure extraction process of coffee. A stainless steel vacuum insulation cup, a heatable cup body and other types of cup bodies and bottles for holding liquid. The covering plate 5 and the lower cover 14 may be made of one or a combination of ABS, PC, silica gel, resin, plastic, glue, ceramic, glass, etc. A control panel 2 is arranged in the machine. The control panel 2 includes a number of buttons. The control panel 2 in the present embodiment is provided with three buttons. The buttons may be presented in the form of power on/off or other buttons with various functions. The buttons are not limited to the following, such as water pumping start/stop button, power switch button or spraying button, liquid discharge button, liquid amount button, extraction time button and other multi-function buttons. At present, the covering plate 5 adopts a covering plate which may be opened upward. A knob-buckling scheme and a side-buckling scheme may also be adopted. The horizontal structure arrangement of the covering plate 5, the extrusion method, and the placement of the filter 9, no matter how it is placed, should be included in the protection scope of the present disclosure.

When the machine is being used: the user first opens the covering plate 5 with the accommodating component 7, adds hot water or ice water into the cup body 20, places the coffee capsule 8 directly above the liquid collecting tank 33, and presses down the covering plate 5 of the accommodating component 7, then the puncture puncturing component 29 in the accommodating component 7 of the coffee capsule 8 punctures the coffee capsule 8. The user places a cup for receiving coffee directly below the flow guide head 18, clicks the control panel 2 on the cover body 1 to turn on the machine, and clicks another control panel 2 to control the water output. Then, coffee extract is started. The indicator light starts to flash, showing the staring of the extracting. The water flow will be drawn into the accommodating component 7 of the coffee capsule 8 through the pumping motor 13. The water flow enters the capsule through the punctured coffee capsule 8, flows into the liquid collecting tank 33 through the filter 9, flows out through the flow guide tube 17 and the flow guide head 18, then flows into the cup for receiving coffee.

The control panel is an interface for the user to interact with the machine, and is not limited to the following: various input and output elements such as buttons, touch screens, and indicator lights. The user issues an instruction through the control panel, such as turning the machine on and off, adjusting the volume, selecting functions, etc. The control panel receives the user's operation information and converts it into electrical signals and transmits it to the circuit board for processing.

The circuit board, usually referring to a main board or a control board, is responsible for receiving signals from the control panel and executing the corresponding control logic operation based on these signals. The circuit board integrates various electronic components, such as an integrated circuit, a resistor, a capacitor, a transistor, and a circuit, etc., which are responsible for signal processing, calculation, logical judgment and sending control commands to various components. The circuit board may also be integrated with a microprocessor or a microcontroller to execute preset programs or algorithms to realize various functions of the machine.

The power supply unit is a part configured to provide required power for the entire coffee machine system. It may be an independent power adapter, a battery pack or a power module integrated on the circuit board. The power supply unit converts external power supply (such as AC or DC) into stable voltage and current required by the internal components of the machine to ensure that components such as the circuit board and the control panel may work stably. In some embodiments, the power supply unit is also responsible for voltage regulation to adapt to power demand changes under different working conditions.

The above are only some implementation methods, which do not limit the protection scope of the present disclosure. Those of ordinary skill in the art may make equivalent replacements or changes according to the technical solutions and concepts of the embodiments of the present disclosure, which are within the technical scope and should be included in the protection scope of the embodiments of the present disclosure. The above are only some embodiments and are not configured to limit the present disclosure. For those of ordinary skill in the art, the present disclosure may have various changes and variations. Any modifications, equivalent replacements, improvements, etc. made within the spirit and principles of the present disclosure should be included in the protection scope of the present disclosure.

What is claimed is:

1. A portable capsule coffee machine, comprising:
a spraying system, comprising an accommodating component, a liquid collecting tank mounted on a bottom of the accommodating component, a spraying space formed between the accommodating component and the liquid collecting tank, and the spraying space is configured to accommodate a coffee capsule;
a pumping system, wherein a liquid inlet tube of the pumping system is configured to extend into internal liquid in a cup body, a liquid outlet tube of the pumping system is connected to the spraying system, and the pumping system is configured to extract liquid from the cup body and transfer the liquid to the liquid outlet tube to allow the liquid to enter an interior of the accommodating component;
a control unit, comprising a control panel for operating an instruction, a circuit board for executing a control instruction, and a power supply unit for providing required electrical energy, wherein the circuit board is electrically connected to the power supply unit and the pumping system respectively.

2. The portable capsule coffee machine according to claim 1, comprising:
a cover, wherein the spraying system is arranged inside the cover, the cup body is configured to store liquid, the cover is detachably connected to the cup body, and the cover is configured to selectively seal an opening of the cup body.

3. The portable capsule coffee machine according to claim 1, wherein the accommodating component is also provided with a puncturing component for puncturing the coffee capsule, and the puncturing component is provided in multiple numbers.

4. The portable capsule coffee machine according to claim 1, wherein the spraying system also comprises a filter and the filter is arranged between the coffee capsule and the liquid collecting tank.

5. The portable capsule coffee machine according to claim 4, wherein a top of the filter is provided with a plurality of top columns, a liquid flow channel is formed among the plurality of top columns, and a bottom of the filter is defined with a plurality of filter holes.

6. The portable capsule coffee machine according to claim 1, wherein the liquid collecting tank is provided with a liquid outlet and the liquid outlet is configured to allow coffee liquid to flow out.

7. The portable capsule coffee machine according to claim 6, wherein the liquid outlet of the liquid collecting tank is connected to a guide tube, one end of the guide tube is in communication with an interior of the liquid collecting tank, and another end of the guide tube is configured to guide out the coffee liquid.

8. The portable capsule coffee machine according to claim 7, wherein the other end of the guide tube is arranged with a guide head.

9. The portable capsule coffee machine according to claim 1, wherein the power supply is electrically connected to the circuit board through a first circuit and a second circuit, and the circuit board is electrically connected to the pumping system through a third circuit and a fourth circuit.

10. The portable capsule coffee machine according to claim 2, wherein the cover body is also provided with a rotatable covering plate, one side of the covering plate is provided with a buckle, and the buckle is buckled to the cover body.

11. The portable capsule coffee machine according to claim 10, wherein another side of the covering plate away from the buckle is provided with a connecting block, a rotating shaft is fixedly mounted inside the connecting block, and the covering plate and the cover body are rotatably connected through the rotating shaft.

12. The portable capsule coffee machine according to claim 1, wherein the cup body is any one of the following: a cup body with a heating function, a cup body with a heating bag provided outside, or a vacuum insulation cup body.

13. The portable capsule coffee machine according to claim 2, wherein the cover body also comprises a lower cover; and a storage space for accommodating the spraying system, the pumping system, and the control unit is formed between the cover body and the lower cover.

14. The portable capsule coffee machine according to claim 13, wherein an inner wall of the cup body is defined with a first thread, the lower cover is defined with a second thread matching with the first thread, and the cup body and the lower cover are connected by means of threaded-connection.

15. The portable capsule coffee machine according to claim 13, wherein the control panel is provided on an outer wall of the cover body.

16. The portable capsule coffee machine according to claim 1, wherein the control panel comprises a plurality of buttons.

17. The portable capsule coffee machine according to claim 10, wherein the accommodating component and the covering plate are integrally arranged or separately arranged.

18. The portable capsule coffee machine according to claim 17, wherein the accommodating component and the covering plate are detachably connected or fixedly connected.

19. The portable capsule coffee machine according to claim 1, wherein the pumping system comprises a pumping motor, a liquid inlet tube, and a liquid outlet tube.

20. A portable capsule coffee machine, comprising:
a spraying system, comprising an accommodating component, a liquid collecting tank mounted on a bottom of the accommodating component, a spraying space formed between the accommodating component and the liquid collecting tank, and the spraying space is configured to accommodate a coffee capsule;
a pumping system, wherein a liquid inlet tube of the pumping system is configured to extend into internal liquid in a cup body, a liquid outlet tube of the pumping system is connected to the spraying system, and the pumping system is configured to extract liquid from the cup body and transfer the liquid to the liquid outlet tube to allow the liquid to enter an interior of the accommodating component to realize the spraying of the coffee capsule; and
a cover, wherein the spraying system is arranged inside the cover, the cup body is configured to store liquid, the cover is detachably connected to the cup body, and the cover is configured to selectively seal an opening of the cup body.
